(19) United States
(12) Patent Application Publication
(10) Pub. No.: US 2026/0336238 A1
(43) Pub. Date: Oct. 29, 2026

(54) WAVEGUIDE ELEMENT MANUFACTURING METHOD BASED ON INJECTION MOLDING PROCESS AND WAVEGUIDE ELEMENT

(71) Applicant: BEIJING NED+ AR DISPLAY TECHNOLOGY CO., LTD., Beijing (CN)

(72) Inventors: Weihong HOU, Beijing (CN); Qichao HOU, Beijing (CN); Mengjing JIAN, Beijing (CN); Qiwei WANG, Beijing (CN); Ximeng WANG, Beijing (CN)

(21) Appl. No.: 19/704,575

(22) Filed: Jun. 11, 2026

Related U.S. Application Data
(63) Continuation of application No. PCT/CN2024/110535, filed on Aug. 8, 2024.

(30) Foreign Application Priority Data
Dec. 19, 2023 (CN) 202311753877.3

(51) Int. Cl. B29D 11/00; G02B 27/01

(52) U.S. Cl. CPC B29D 11/00663; G02B 27/0172

(57) ABSTRACT

The present invention discloses a waveguide element manufacturing method based on an injection molding process, and a waveguide element produced by this method. The waveguide element includes: a bevel-toothed spectroscopic element, a primary mirror, and a compensation mirror; wherein, the bevel-toothed spectroscopic element is a bevel-toothed thin film formed by a plurality of transmission films and a plurality of spectroscopic films that are alternately arranged; the primary mirror, similar in size to a diopter lens, features a groove and a tooth tip structure on the bottom surface of the groove; the compensation mirror, matching the size of the groove, and has a tooth tip structure on the side facing the groove; and the compensation mirror causes the bevel-toothed spectroscopic element to be sandwiched between the tooth tip structure of the groove and the tooth tip structure of the compensation mirror.

### CROSS-REFERENCE TO RELATED APPLICATIONS

This application is a bypass continuation application of PCT application no.: PCT/CN2024/110535. This application claims priorities from PCT Application PCT/CN2024/110535, filed Aug. 8, 2024, and from Chinese patent application 202311753877.3, filed Dec. 19, 2023, the contents of which are incorporated herein in the entirety by reference.

### TECHNICAL FIELD

The present invention relates to a waveguide element manufacturing method based on an injection molding process, and relates to a waveguide element manufactured by the method.

### BACKGROUND

An arrayed waveguide, also known as a geometric waveguide, achieves outcoupling of a light ray in the visual axis direction of a human eye by disposing a plurality of partially reflective surfaces parallel to each other within a substrate to form an outcoupling element. In a two-dimensional arrayed waveguide, a steering element is further provided, which is formed by partially reflective surfaces that are parallel to each other. The orientation of the steering element is different from that of the outcoupling element.

For a manufacturing method of an arrayed waveguide, refer to the content disclosed in Chinese patent document No. CN107111135B. The method involves providing multiple transparent plates with polished opposite surfaces that are parallel to each other. One surface of each plate is coated with a partially reflective coating. The transparent plates are then bonded together to create a stack, which is cut along parallel planes with a bevel angle to produce an optical element. This manufacturing process is complex, difficult, and expensive, making it challenging to manufacture an arrayed waveguide using this method. To ensure process precision, most arrayed waveguide materials are glass. However, lenses made from glass are heavy and have poor drop resistance.

### SUMMARY

A primary technical problem to be resolved by the present invention is to provide a waveguide element manufacturing method based on an injection molding process.

The present invention aims to resolve another technical problem by providing a waveguide element that is obtained through the manufacturing method described above.

According to a first aspect of embodiments of the present invention, a waveguide element manufacturing method based on an injection molding process is provided, including the following steps:
providing a mold of a primary mirror that includes a plate-shaped waveguide element with a predetermined bevel-toothed groove formed therein, where a tooth tip structure is provided on a bottom surface of the groove;
providing a bevel-toothed spectroscopic element, where the bevel-toothed spectroscopic element is a bevel-toothed thin film formed by a plurality of spectroscopic films and a plurality of transmission films that are alternately arranged and sequentially connected to each other, and the bevel-toothed spectroscopic element is a profiling spectroscopic film;
placing the bevel-toothed spectroscopic element in an injection mold of the primary mirror of the waveguide element, and manufacturing a primary mirror with a bevel-toothed spectroscopic feature by an in-mold injection molding process;
providing a compensation mirror having a tooth tip structure and is manufactured by the in-mold injection molding process, where the compensation mirror is constructed to directly form a fitting structure embeddable in the bevel-toothed groove of the primary mirror; and
embedding the compensation mirror in the groove of the primary mirror, and bonding the compensation mirror and the groove of the primary mirror to sandwich the bevel-toothed spectroscopic element between the bottom surface of the groove and the tooth tip structure of the compensation mirror.

According to a second aspect of the embodiments of the present invention, a waveguide element manufacturing method based on an injection molding process is provided, including the following steps:
providing a primary mirror of a waveguide element having a predetermined groove and manufactured by an in-mold injection molding process, where a bevel-toothed tooth tip structure is provided on a bottom surface of the groove;
providing a bevel-toothed spectroscopic element, where the bevel-toothed spectroscopic element is a bevel-toothed thin film formed by a plurality of spectroscopic films and a plurality of transmission films that are alternately arranged and sequentially connected to each other, and the bevel-toothed spectroscopic element is a profiling spectroscopic film;
providing an injection mold of a compensation mirror having a predetermined bevel-toothed tooth tip structure, placing the bevel-toothed spectroscopic element in the injection mold of the compensation mirror, and processing a compensation mirror with a bevel-toothed spectroscopic feature by the in-mold injection molding process; and
embedding the compensation mirror in the groove of the primary mirror, and bonding the compensation mirror and the groove of the primary mirror to sandwich the bevel-toothed spectroscopic element between the bottom surface of the groove and the tooth tip structure of the compensation mirror.

Preferably, during manufacturing of the bevel-toothed spectroscopic element, a substantially planar transmissive film material is first provided, a plurality of regions on a surface of the transmissive film material are coated with a spectroscopic film to form spectroscopic film regions, and during the coating of the spectroscopic film, a flat mask is shielded between adjacent spectroscopic film regions to form a transmission film region, where the spectroscopic film regions and the transmission film regions are alternately arranged; and then, the plurality of spectroscopic film regions and the plurality of transmission film regions are caused in a manner of hot bending or profiling lamination to form a spectroscopic film array and a transmission film array, respectively, so that the film material has a same shape as the tooth tip structure in the groove of the waveguide.

Preferably, in the spectroscopic film array, a reflectivity of the spectroscopic film ranges from 5% to 80%, and transmission-reflection ratios of the plurality of spectroscopic films gradually decrease along a propagation direction of a light ray.

Preferably, the transmission film has a light transmittance not less than 98%.

Preferably, the bevel-toothed groove has an asymmetric structure, and a characteristic angle between a spectroscopic film and a transmission film that are adjacent ranges from 450 to 90°.

According to a third aspect of the embodiments of the present invention, a waveguide element manufactured by the waveguide element manufacturing method described above is provided, including:
at least one bevel-toothed spectroscopic element, where the bevel-toothed spectroscopic element is a bevel-toothed thin film formed by a plurality of transmission films and a plurality of spectroscopic films that are alternately arranged, where the plurality of transmission films and the plurality of spectroscopic films are arranged in different directions, and the plurality of transmission films and the plurality of spectroscopic films are alternately arranged and sequentially connected to form the bevel-toothed thin film;
a primary mirror, where the primary mirror is of a similar size to a diopter lens and has a groove therein, and a tooth tip structure having a same shape as the bevel-toothed thin film is provided on a bottom surface of the groove; and
at least one compensation mirror, where the compensation mirror has a same size as the groove, and a tooth tip structure having a same shape as the bevel-toothed thin film is provided on a side of the compensation mirror facing the groove; and
the compensation mirror is embedded in the groove of the primary mirror, and the bevel-toothed spectroscopic element is sandwiched between the tooth tip structure of the groove and the tooth tip structure of the compensation mirror.

Preferably, there are two bevel-toothed spectroscopic elements: a steering element and an outcoupling element;
two grooves are provided in the primary mirror for accommodating the steering element and the outcoupling element, respectively; and
there are two compensation mirrors for fastening the steering element and the outcoupling element in the corresponding grooves, respectively.

Preferably, the outcoupling element is provided at a position of the primary mirror corresponding to a visual axis of a human eye; and
the steering element is provided at an end portion of the primary mirror away from the visual axis of the human eye.

Preferably, a diopter compensation sheet is provided at a position, corresponding to an outcoupling region, on a surface of a side of the waveguide element close to a human eye, and there is an air gap between the diopter compensation sheet and the waveguide element.

Preferably, the waveguide element has planar or curved surfaces on two sides, and there is a surface shape difference between the two surfaces on the two sides to provide diopter compensation.

Preferably, a transmittance compensation film is provided on a surface of the primary mirror in which the groove is provided, and an opening is formed at a position of the transmittance compensation film corresponding to the bevel-toothed spectroscopic element.

Preferably, a protective film is provided on a surface of the primary mirror away from the compensation mirror.

Preferably, the primary mirror, the protective film, and the transmittance compensation film are one-step injection molded to form a component.

The waveguide element provided in the present invention includes at least one bevel-toothed spectroscopic element, a primary mirror, and at least one compensation mirror. The bevel-toothed spectroscopic element is a bevel-toothed thin film formed by a transmission film array and a spectroscopic film array. The primary mirror has a groove therein. A tooth tip structure is provided on a bottom surface of the groove. The compensation mirror is constructed to directly form a fitting structure embeddable in a bevel-toothed groove of the primary mirror. A tooth tip structure is provided on a bottom surface of the compensation mirror. The compensation mirror and the bevel-toothed spectroscopic element are embedded in the groove of the primary mirror. The bevel-toothed spectroscopic element is sandwiched between the tooth tip structure of the primary mirror and the tooth tip structure of the compensation mirror. Additionally, the at least one bevel-toothed spectroscopic element is an integrated bevel-toothed spectroscopic element, which is placed in either an injection mold of the primary mirror or an injection mold of the compensation mirror. Both the primary mirror and the compensation mirror are manufactured separately using an in-mold injection molding process. Then, the primary mirror and the compensation mirror are bonded together to manufacture the waveguide element with a bevel-toothed spectroscopic feature. This simplifies the manufacturing process of the waveguide element. The bevel-toothed spectroscopic element may be a steering element located in a steering region or an outcoupling element located in an outcoupling region of a waveguide element. A one-dimensional arrayed waveguide element and a two-dimensional arrayed waveguide element can be manufactured by the in-mold injection molding process.

### BRIEF DESCRIPTION OF THE DRAWINGS

FIG. 1 is a schematic structural view of a one-dimensional waveguide element according to the present invention;

FIG. 2 is an exploded schematic structural view of a one-dimensional waveguide element according to the present invention;

FIG. 3 is another exploded schematic structural view of the one-dimensional waveguide element according to the present invention;

FIG. 4 is a schematic view of an optical path of the one-dimensional waveguide element shown in FIG. 1;

FIG. 5 is a schematic structural view of a bevel-toothed spectroscopic element in the one-dimensional waveguide element;

FIG. 6 is a schematic structural view of a primary mirror in the one-dimensional waveguide element;

FIG. 7 is a schematic structural view of a compensation mirror in the one-dimensional waveguide element;

FIG. 8, FIG. 9, and FIG. 10 are each a variation example of the one-dimensional waveguide element according to the present invention;

FIG. 11 is a schematic structural view of a two-dimensional waveguide element according to the present invention; and

FIG. 12 is another schematic structural view of the two-dimensional waveguide element according to the present invention.

### DETAILED DESCRIPTION

The technical solutions of the present invention are described below in further detail by using specific embodiments with reference to the accompanying drawings.

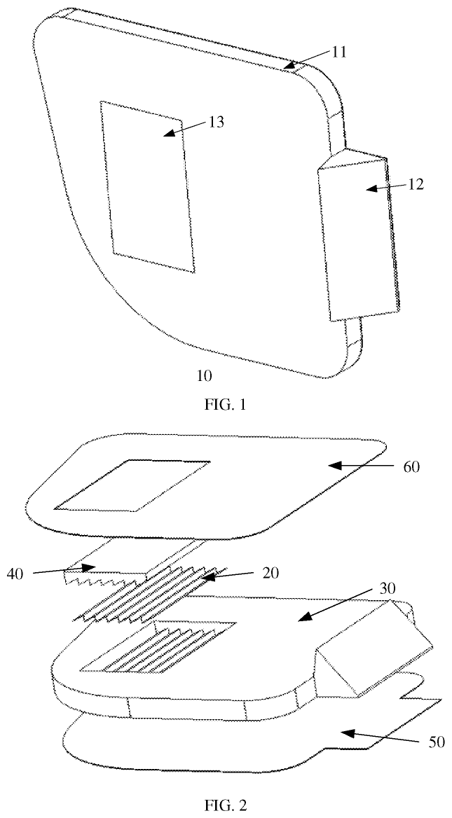

As shown in FIG. 1, a one-dimensional waveguide element 10 provided in the present invention is designed for the near-eye display of augmented reality (AR). It consists of a substrate 11, an incoupling end 12, and an outcoupling element 13. The substrate 11 is made of a transmissive material. The incoupling end 12 is provided on a side of the substrate 11. The outcoupling element 13 is embedded in a position of the substrate 11 away from the incoupling end 12. The outcoupling element 13 includes an array formed by a plurality of spectroscopic surfaces, correspondingly forming an outcoupling region of the waveguide element 10. A center of the outcoupling element 13 corresponds to a visual axis of a human eye during use. A collimated light ray emitted from a projector enters the substrate 11 through the incoupling end 12, undergoes a plurality of total reflections within the substrate 11, and is coupled out of the waveguide through the outcoupling element 13 to enter the human eye for imaging. In addition, an ambient light ray passes through the substrate and enters the human eye for imaging. In this way, a virtual image is superimposed based on real environment imaging, thereby achieving an AR display effect.

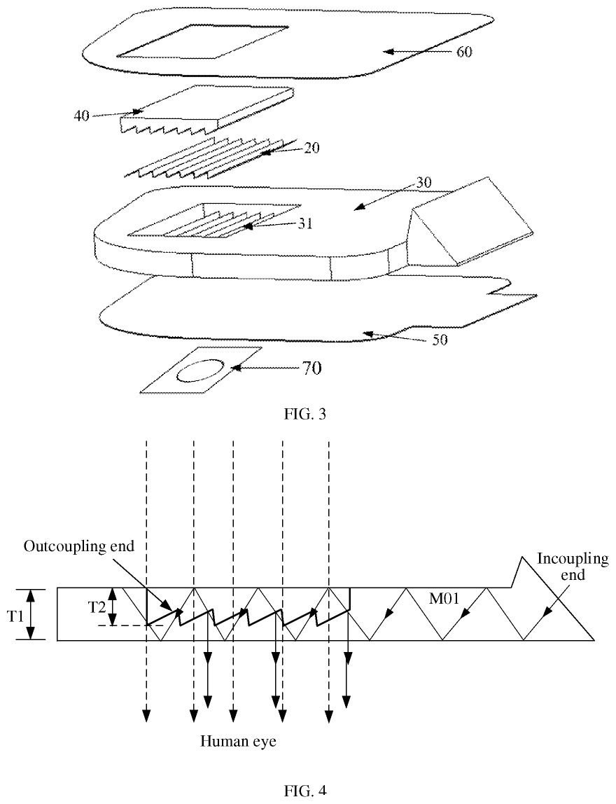

Specific structures of the one-dimensional waveguide element provided in the present invention are shown in FIG. 2 and FIG. 3, and include: a bevel-toothed spectroscopic element 20, a primary mirror 30, and a compensation mirror 40. The bevel-toothed spectroscopic element 20 is a bevel-toothed thin film formed by a plurality of transmission films and a plurality of spectroscopic films that are alternately arranged. The primary mirror 30 has a similar size as a diopter lens. A groove 31 is provided at a position of the primary mirror 30 corresponding to the outcoupling region. A tooth tip structure having a same shape as the bevel-toothed thin film is provided on a bottom surface of the groove 31. The compensation mirror 40 has a same size as the groove 31. A tooth tip structure having a same size as the bevel-toothed thin film is provided on a surface of the compensation mirror 40 facing the groove 31. The compensation mirror 40 and the bevel-toothed spectroscopic element 20 are embedded in the groove 31 of the primary mirror 30, with the bevel-toothed spectroscopic element 20 sandwiched between the tooth tip structure on the bottom surface of the groove 31 and the tooth tip structure of the compensation mirror 40.

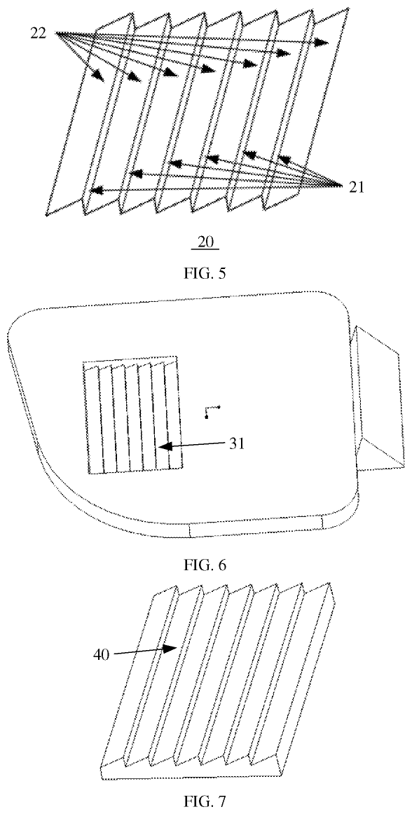

As shown in FIG. 4, the primary mirror 30 and the compensation mirror 40 as a whole form a light-transmissive substrate of the optical waveguide element. The bevel-toothed spectroscopic element 20 is provided in the outcoupling region of the substrate. The bevel-toothed spectroscopic element 20 contains a plurality of spectroscopic film that form a spectroscopic film array 22. This array achieves outcoupling of a spectroscopic surface array, and is configured to expand a light ray transmitted in total reflection within the substrate, and outcouple the light ray from the substrate to the human eye. The reflectivity of the spectroscopic film ranges from 5% to 80%. Spectroscopic films at different positions have different reflectivities. Transmission-reflection ratios of the plurality of spectroscopic films gradually decrease along the propagation direction of the light ray. The plurality of transmission films in the bevel-toothed spectroscopic element 20 form a transmission film array 21, configured to transmit a light ray. In addition, the transmission film array 21 and the spectroscopic film array 22 are connected as a whole to form the bevel-toothed thin film. The transmission film in the transmission film array should have a light transmittance of not less than 98%, preferably, higher than 99.5%. This allows maximum light to pass through, and reducing stray light caused by reflections from the transmission film.

FIG. 5 is a schematic structural view of the bevel-toothed spectroscopic element 20. The bevel-toothed spectroscopic element 20 is a bevel-toothed thin film formed by a transmission film array 21 and a spectroscopic film array 22. The transmission film array 21 consists of multiple transmission films arranged in parallel, while the spectroscopic film array 22 consists of multiple spectroscopic films also arranged in parallel. The transmission films and the spectroscopic films are arranged in different directions and connected to each other to form the bevel-toothed thin film. A transmission film and a spectroscopic film that are adjacent form a spectroscopic unit. The spectroscopic unit has a width that varies inversely with a quantity of spectroscopic elements included in the outcoupling region. When the spectroscopic unit has a larger width, a smaller quantity of spectroscopic units are included in the outcoupling region. Preferably, the width of the spectroscopic unit ranges from 0.2 mm to 3 mm. The bevel-toothed spectroscopic element includes 5 to 50 spectroscopic units. A characteristic angle, which forms a bevel-toothed state, between the transmission film and the spectroscopic film that are adjacent (an angle formed between the two films) ranges from 45° to 90°. Each time a light ray passes through the spectroscopic film, a part of the light ray is outcoupled and the remaining part continues to be transmitted downward. The outcoupling feature that the light ray continues to be transmitted downward after being refracted by a transmission film can effectively eliminate stray light at an outcoupling end.

To achieve a uniform distribution of energy in the outcoupled light ray, the transmission-reflection ratios of the spectroscopic films in array 22 gradually decrease along the propagation direction of the light ray. Preferably, the entire spectroscopic film array 22 should be divided into multiple regions along the transmission direction of the light ray. In each region, spectroscopic films with the same transmission-reflection ratio are used. Transmission-reflection ratios of spectroscopic films in different regions gradually decrease along the transmission direction of the light ray.

The manufacturing method of a waveguide element based on an injection molding process described in this application begins with the provision of molds for a primary mirror, a compensation mirror, and a bevel-toothed spectroscopic element. Then, the bevel-toothed spectroscopic element is placed in either the mold of the primary mirror or the compensation mirror. This results in the formation of a primary mirror or a compensation mirror with a bevel-toothed spectroscopic feature through a one-piece injection molding process known as in-mold injection molding. Then, the component formed by injection molding and the compensation mirror or the primary mirror are bonded together, so that the bevel-toothed spectroscopic element is fastened between a tooth tip structure of the primary mirror and a tooth tip structure of the compensation mirror to obtain a waveguide element with the bevel-toothed spectroscopic feature.

The bevel-toothed spectroscopic element 20 is located between an outcoupling end of the primary mirror 30 and the compensation mirror 40, and is a profiling spectroscopic film. First, a substantially planar transmissive film material is provided. A plurality of regions on a surface of the transmissive film material are coated with a spectroscopic film to form spectroscopic film regions. During the coating of the spectroscopic film, a flat mask is shielded between adjacent spectroscopic film regions to form a transmission film region. The spectroscopic film regions and the transmission film regions are alternately arranged in the film material. Through hot bending, profiling lamination, or in other manners, the film is caused to have a same shape as the waveguide outcoupling end. The plurality of spectroscopic film regions are arranged in an array along a first direction. The plurality of transmission film regions are arranged in an array along a second direction. The first direction intersects the second direction. A characteristic angle between a spectroscopic film and a transmission film that are adjacent ranges from 45° to 90°, and preferably, the characteristic angle causes the spectroscopic films and the transmission films to be distributed asymmetrically on two sides of the intersection. Then, the bevel-toothed spectroscopic element is placed in an injection mold of the primary mirror or the compensation mirror. Through an in-mold injection molding technology, the primary mirror or the compensation mirror (preferably, the primary mirror) is integrated with a composite film to obtain a primary mirror with a bevel-toothed spectroscopic feature or a compensation mirror with a bevel-toothed spectroscopic feature. Then, the primary mirror and the compensation mirror are bonded together to form a waveguide element. The position of the transmission film after the formation of the waveguide element tends to be perpendicular to a surface of the substrate of the waveguide element. The characteristic angle between the spectroscopic film and the transmission film that are adjacent varies according to an angle between beveled teeth and the surface of the substrate.

Compared with films arranged in a dispersed manner, the bevel-toothed thin film has the following advantage: The bevel-toothed thin film can be formed in one step, which can greatly reduce costs and enable mass production. For the waveguide element provided in the present invention, a bevel-toothed thin film formed by a spectroscopic film array and a transmission film array is provided, then, the bevel-toothed thin film is integrated with a primary mirror or a compensation mirror by an in-mold injection molding process, and the primary mirror and the compensation mirror are bonded together to achieve processing of a waveguide element. This is simple in structure and cost-effective. In addition, compared with a manner of coating on a tooth tip structure of a primary mirror or a compensation mirror that has been formed through injection molding, the manner of in-mold injection molding of placing an integrated bevel-toothed thin film in a mold of a primary mirror or a compensation mirror to achieve a primary mirror or a compensation mirror with a bevel-toothed spectroscopic feature. This method helps avoid incomplete coating, such as black edges and black lines, that can occur during the coating process due to mutual shielding between beveled teeth.

FIG. 2 and FIG. 3 show the two structures of the one-dimensional waveguide element. A protective film is provided on both the front surface and the rear surface of the substrate. In the following, a description is provided in a front direction and a rear direction of the visual axis of the human eye. That is, the description is provided with a side of the waveguide element close to the human eye as the rear side, and a side away from the human eye side as a front side. In the embodiments shown in FIG. 2 and FIG. 3, the compensation mirror 40 is provided in a groove on a front side of the primary mirror 30 away from the human eye. In other embodiments not shown, the compensation mirror 40 may alternatively be provided in a groove on a rear side of the primary mirror 30 facing the human eye. The position where the compensation mirror 40 is provided is not limited here.

In FIG. 2, the waveguide element includes: the bevel-toothed spectroscopic element 20, the primary mirror 30, the compensation mirror 40, a protective film 50, and a transmittance compensation film 60. The primary mirror 30 has a similar size as the diopter lens. A groove 31 is provided in a front surface of the primary mirror 30 away from the human eye. The bevel-toothed spectroscopic element 20 and the compensation mirror 40 are embedded in the groove 31 of the primary mirror 30. The bevel-toothed spectroscopic element 20 and the primary mirror 30 or the compensation mirror 40 are integrally formed through injection molding. In addition, the primary mirror 30 and the compensation mirror 40 are bonded together.

The front surface (the portion excluding the groove) of the primary mirror 30 may be a planar or curved surface. A rear surface of the primary mirror 30 may be a planar or curved surface. In this way, a human eye of a user can be adapted through a surface shape difference between the front and rear surfaces.

A structure of a surface of the compensation mirror 40 facing the primary mirror is adapted to the groove 31. A front surface on a side of the compensation mirror 40 away from the human eye has a same surface shape as the front surface of the primary mirror 30, that is, a planar or curved surface. After the primary mirror 30 and the compensation mirror 40 are bonded together, their front surfaces form a smooth surface of a consistent surface shape. The compensation mirror 40 fits the primary mirror 30 to provide diopter compensation in a perspective direction.

In FIG. 2, the protective film 50 is provided on a rear side of the primary mirror 30 away from the compensation mirror 40. The protective film 50 has a same size as the overall size of the primary mirror 30. The protective film 50 is a hardened coating or a hardened film layer that serves to protect the primary mirror 30 and prevent damage to its rear surface. Certainly, the normal function of the waveguide element is not affected when the protective film 50 is present.

The transmittance compensation film 60 is provided on the front surface of the primary mirror 30 (that is, the side away from the human eye side). There is an opening at a position of the transmittance compensation film 60 corresponding to the groove 31. The opening has a same shape as the groove 31 and the compensation mirror 40. The transmittance compensation film 60 has a same shape as the portion of the front surface of the primary mirror 30 excluding the groove 31. The transmittance compensation film 60 is a special protective film used to provide transmittance compensation in the perspective direction. This causes the color and transmittance of the entire waveguide element (including an outcoupling region and a peripheral region) in the perspective direction to be substantially the same. In addition, the transmittance compensation film 60 may serve to protect the primary mirror 30 to prevent the front surface of the primary mirror 30 from being damaged.

As shown in FIG. 3, the waveguide element includes: the bevel-toothed spectroscopic element 20, the primary mirror 30, the compensation mirror 40, a protective film 50, a transmittance compensation film 60, and a diopter compensation sheet 70. The protective film 50 is provided on a rear side of the primary mirror 30 away from the compensation mirror 40. The transmittance compensation film 60 is provided on a front surface of the primary mirror 30. In addition, the diopter compensation sheet 70 is further provided on the side of the waveguide element close to the human eye. There is an air gap between the diopter compensation sheet 70 and the primary mirror 30. The diopter compensation sheet 70 and the protective film 50 are used in conjunction to ensure that the overall picture is free of perspective distortion. The diopter compensation sheet is also responsible for ensuring light ray transmission and diopter compensation in a perspective direction, and can provide optical focus compensation for myopic people.

In this embodiment, the structures of the primary mirror 30 and the compensation mirror 40 are shown in FIG. 6 and FIG. 7. The primary mirror 30 may be provided with the groove 31 in only the outcoupling region. The compensation mirror 40 has a same size as the outcoupling region. The bottom surface of the groove 31 and the surface of the compensation mirror 40 facing the primary mirror 30 have a same size as the bevel-toothed spectroscopic element 20, and each have a tooth tip structure fitting the bevel-toothed thin film. It should be ensured that the tooth tip structures of the primary mirror 30 and the compensation mirror 40 are as sharp as possible, to avoid occurrence of stray light on a display screen. This can be caused by rounded corners forming at a tip portion of the bevel-toothed thin film. Additionally, ensuring sharp structures will help avoid a sense of grating in the perspective direction.

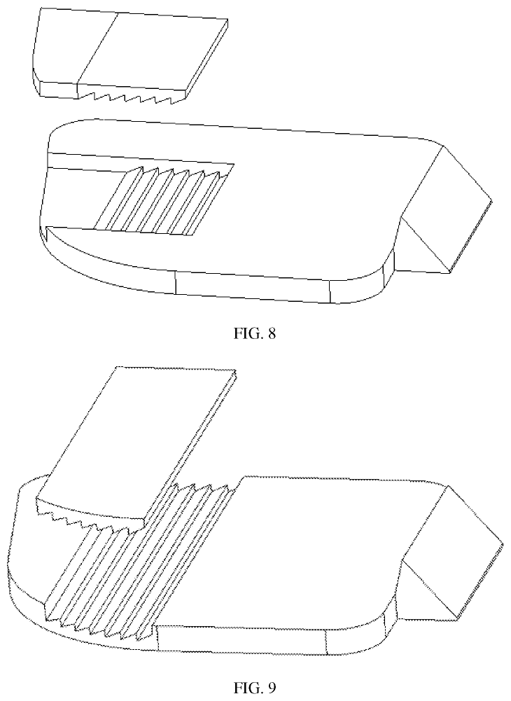

FIG. 8 to FIG. 10 show three variant embodiments of the primary mirror and the compensation mirror. The size of the groove 31 formed on the front surface of the primary mirror 30 exceeds the outcoupling region, and extends from the outcoupling region to an edge of the primary mirror 30. The compensation mirror 40 has a structure corresponding to the groove 31. The compensation mirror 40 includes two parts: a region corresponding to the outcoupling region and an auxiliary region corresponding to a normal perspective region. Compared with a manner of providing a compensation mirror in only the outcoupling region, this manner of providing the compensation mirror including the auxiliary region is less difficult to assemble with the primary mirror.

Specifically, in the structure shown in FIG. 8, the groove 31 extends from the outcoupling region along an arrangement direction of the spectroscopic surfaces to an edge on a side of the primary mirror 30 away from the incoupling end. The bottom surface of the groove 31 includes a bevel-toothed tooth tip structure and a planar portion. Correspondingly, the compensation mirror 40 includes a bevel-toothed tooth tip structure and a planar portion. The compensation mirror 40 and the bevel-toothed spectroscopic element 20 are embedded in the groove 31 to cause the bevel-toothed spectroscopic element 20 to be sandwiched between the tooth tip structures of the groove 31 and the compensation mirror 40, thereby achieving processing of the waveguide element.

In the structure shown in FIG. 9, the groove 31 extends from the outcoupling region along a length direction of the spectroscopic surface bidirectionally to edges on two opposite sides of the primary mirror 30. In this embodiment, the tooth tip structure of the bottom surface of the groove 31 and the groove 31 extend together to the edges on the two opposite sides of the primary mirror 30. Correspondingly, the compensation mirror 40 includes a tooth tip structure running through a width direction of the primary mirror. In this embodiment, a length of the bevel-toothed spectroscopic element 20 may be the same as that of the outcoupling region, or that of the tooth tip structure of the compensation mirror 40. The compensation mirror 40 and the bevel-toothed spectroscopic element 20 are embedded in the groove 31. The bevel-toothed spectroscopic element 20 is sandwiched between the tooth tip structures, corresponding to the outcoupling region, of the groove 31 and the compensation mirror 40, thereby achieving processing of the substrate of the waveguide element. In this embodiment, a length of the spectroscopic film in the bevel-toothed spectroscopic element 20 is preferably the same as that of the compensation mirror 40, to facilitate the manufacturing of the waveguide element.

In the structure shown in FIG. 10, the groove 31 extends from the outcoupling region along a length direction of the spectroscopic surface bidirectionally to edges on two opposite sides of the primary mirror 30. It also extends along an arrangement direction of the spectroscopic surface array to an edge on a side of the primary mirror 30 that is away from an outcoupling end. In this embodiment, the tooth tip structure of the bottom surface of the groove 31 and the groove 31 extend together to the edges on the two opposite sides of the primary mirror 30. In addition, the bottom surface of the groove 31 further has a planar portion corresponding to the perspective region. Correspondingly, the compensation mirror 40 includes a tooth tip structure running through a width direction of the primary mirror and a planar portion corresponding to the perspective region. Similarly, in this embodiment, a length of the bevel-toothed spectroscopic element 20 may be the same as that of the outcoupling region, or that of the tooth tip structure of the compensation mirror 40. The compensation mirror 40 and the bevel-toothed spectroscopic element 20 are embedded in the groove 31, so that the bevel-toothed spectroscopic element 20 is sandwiched between the tooth tip structures, corresponding to the outcoupling region, of the groove 31 and the compensation mirror 40, thereby achieving processing of the substrate of the waveguide element. In this embodiment, a length of the spectroscopic film in the bevel-toothed spectroscopic element 20 is preferably the same as that of the tooth tip structure of the compensation mirror 40, to facilitate the manufacturing of the waveguide element.

For the waveguide element provided in the present invention, a bevel-toothed thin film formed by a spectroscopic film array and a transmission film array is provided. Next, the bevel-toothed thin film is integrated with a primary mirror or a compensation mirror by an in-mold injection molding process. Finally, the primary mirror and the compensation mirror are bonded together to achieve processing of a waveguide element. This method is simple in structure and low in costs.

Table 1 shows a design example of the waveguide element provided in the present invention. The waveguide element has dimensions in a plane perpendicular to a visual axis direction in a range of 20 mm×15 mm to 55 mm×40 mm, and has a thickness in the visual axis direction in a range of 0.8 mm to 5 mm. The outcoupling region of the waveguide element has dimensions in a range of 12 mm×15 mm to 30 mm×30 mm. The tooth tip structure of the compensation mirror has parameters corresponding to those of the outcoupling region.

TABLE 1
Design parameter table of one-dimensional
arrayed waveguide element

| | | |
|---|---|---|
| Primary mirror | Overall | Length: 20 mm to 55 mm |
| | | Width: 15 mm to 40 mm |
| | | Thickness T1: 0.8 mm to 5 mm |
| | Outcoupling | Length: 12 mm to 30 mm |
| | region | Width: 15 mm to 30 mm |
| Bevel-toothed | Spectroscopic | Length L: 0.2 mm to 3 mm |
| spectroscopic | unit | Quantity N: 5 to 50 |
| element | | Characteristic angle between |
| | | spectroscopic film and |
| | | transmission film: 45° to 90° |
| Compensation | Tooth tip | Length: 12 mm to 30 mm |
| mirror | structure | Width: 15 mm to 30 mm |
| | region | Thickness T2: 0.5 mm to 3 mm |

The waveguide element may be implemented by the in-mold injection molding process. The primary mirror or the compensation mirror and the bevel-toothed spectroscopic element may be integrally formed through one-piece injection molding by the in-mold injection molding process to form a component, and the component formed by injection molding and the compensation mirror or the primary mirror are bonded together to achieve the manufacturing of the entire waveguide element. The steps are simple.

The following describes in detail manufacturing methods of the waveguide elements shown in FIG. 2 and FIG. 3.

A first manufacturing method of a waveguide element includes the following steps:

S101: Provide a bevel-toothed spectroscopic element.

The bevel-toothed spectroscopic element is a bevel-toothed thin film formed by a plurality of spectroscopic films and a plurality of transmission films that are alternately arranged and sequentially connected to each other. The bevel-toothed spectroscopic element is a profiling spectroscopic film.

During manufacturing, a substantially planar transmissive film material is first provided. A plurality of regions on a surface of the transmissive film material are coated with a spectroscopic film to form spectroscopic film regions. During the coating of the spectroscopic film, a flat mask is shielded between adjacent spectroscopic film regions to form a transmission film region. The spectroscopic film regions and the transmission film regions are alternately arranged in the film. Then, the plurality of spectroscopic film regions and transmission film regions are caused through hot bending, profiling lamination, or in other manners to create a spectroscopic film array and a transmission film array that are alternately arranged, respectively, so that the film material has a same shape as the tooth tip structure in the groove of the primary mirror. A characteristic angle between a spectroscopic film and a transmission film that are adjacent meets a characteristic angle requirement.

S102: Provide a mold of a primary mirror that includes a plate-shaped waveguide element having a predetermined bevel-toothed groove formed therein, where a tooth tip structure is provided on a bottom surface of the groove.

S103: Place the bevel-toothed spectroscopic element in an injection mold of the primary mirror to process a primary mirror with a bevel-toothed spectroscopic feature using an in-mold injection molding process. The bevel-toothed spectroscopic element and the primary mirror are molded together to form a component.

During the injection molding, the bevel-toothed spectroscopic element is first placed in the injection mold of the primary mirror at a position corresponding to the tooth tip structure of the groove. A molten resin material is injected into the injection mold, and the component is obtained after cooling.

S104: Provide a mold of a compensation mirror having a bevel-toothed protrusion, and manufacture a compensation mirror by the injection molding process, where the compensation mirror is constructed to directly form a fitting structure embeddable in the bevel-toothed groove of the primary mirror. Inject a molten resin material into an injection mold of the compensation mirror to obtain a compensation mirror after cooling, where a tooth tip structure is formed on a surface on a side of the compensation mirror facing the primary mirror.

S105: Place the compensation mirror in the groove of the primary mirror and bonding the compensation mirror and the groove of the primary mirror together to form a waveguide element with the distinctive bevel-toothed spectroscopic feature.

A second manufacturing method of a waveguide element includes the following steps:

S201: Provide a bevel-toothed spectroscopic element, and the manufacturing method of the bevel-toothed spectroscopic element is the same as the above and is not repeated herein.

S202: Provide a primary mirror of a waveguide element that has a predetermined groove to manufacture a primary mirror by an injection molding process; and inject a molten resin material into an injection mold of the primary mirror to obtain the primary mirror after cooling, The primary mirror will have a groove on its surface and a tooth tip structure on a bottom surface of the groove.

S203: Provide an injection mold of a compensation mirror having a predetermined bevel-toothed protrusion, where a shape the bevel-toothed protrusion corresponds to that of a tooth tip structure of the compensation mirror.

S204: Place the bevel-toothed spectroscopic element in the injection mold of the compensation mirror, and process a compensation mirror with a bevel-toothed spectroscopic feature by an in-mold injection molding process. This process results in integration of the bevel-toothed spectroscopic element and the compensation mirror to form a single component.

During the injection molding, the bevel-toothed spectroscopic element is first placed in the injection mold of the compensation mirror at a position corresponding to the tooth tip structure. The molten resin material is injected into the injection mold, and the component is obtained after cooling.

S205: Place the compensation mirror in the groove of the primary mirror, and bonding the compensation mirror and the groove of the primary mirror together to form a waveguide element with the bevel-toothed spectroscopic feature.

In the two manufacturing methods mentioned above, the combination of the bevel-toothed spectroscopic element and the primary mirror or the compensation mirror is achieved through the in-mold injection molding process. Both processes can achieve the processing of the waveguide element. Preferably, the bevel-toothed spectroscopic element is placed in the mold of the primary mirror to achieve the injection molding with the primary mirror.

In addition, during steps S102, S103, and S202 of manufacturing the primary mirror using the injection molding process, the in-mold injection molding process can also be used to integrally form the protective film, the transmittance compensation film, and the primary mirror through injection molding. The protective film and the transmittance compensation film are positioned within the primary mirror mold, followed by the injection of molten resin material. This results in a primary mirror with both rear surface featuring the protective film.

Manufacturing the waveguide element using the in-mold injection molding process can simplify complex coating, bonding, and cutting processes into a few simple in-mold injection molding steps. In this way, the waveguide element can be obtained through bonding. Therefore, the structure is simple and the steps are simplified. In addition, the stability of the process and a pass rate of products can be greatly improved.

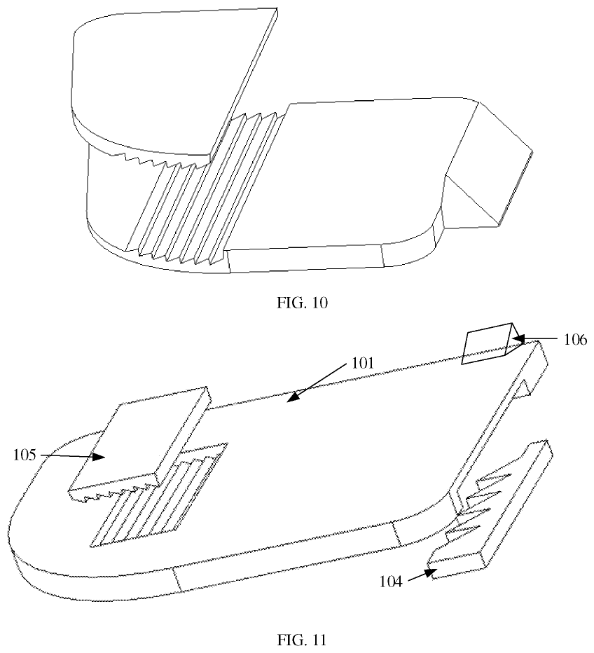

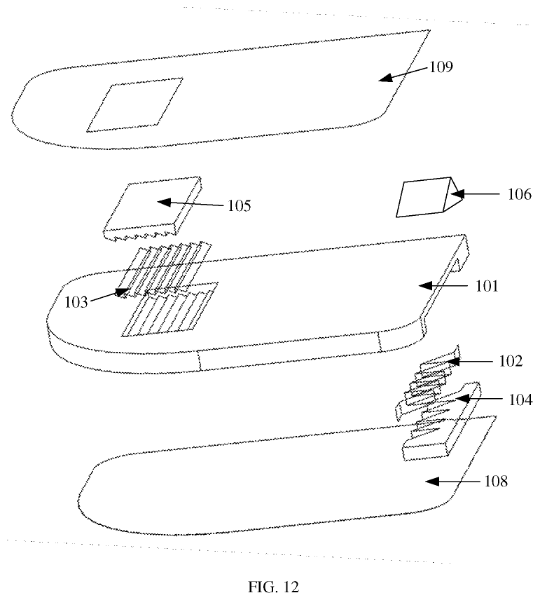

FIG. 11 and FIG. 12 show another waveguide element provided in the present invention, which is a two-dimensional arrayed waveguide. It includes a primary mirror 101, an incoupling end 106, two bevel-toothed spectroscopic elements, and two compensation mirrors. The two bevel-toothed spectroscopic elements are: a steering element 102 and an outcoupling element 103. The steering element 102 and the outcoupling element 103 consists of bevel-toothed thin films, which are formed by a plurality of spectroscopic films and a plurality of transmission films arranged alternately. These elements vary in size and are positioned at different positions on a substrate. The primary mirror 101 is provided with two grooves, one for accommodating the steering element 102 and a compensation mirror 104, and the other one for accommodating the outcoupling element 103 and a compensation mirror 105. The compensation mirror 104 and the compensation mirror 105 are used for fastening the steering element 102 and the outcoupling element 103 in the corresponding grooves, respectively. In addition, the compensation mirrors 104 and 105 and the primary mirror 101 form a complete substrate of the waveguide element.

The steering element 102 and the outcoupling element 103 are located at opposite ends of the primary mirror 101. The steering element 102 is provided at a position in the substrate close to a temple, that is, an end portion of the substrate away from a visual axis of a human eye. The outcoupling element 103 is provided at a position in the substrate close to a nose pad. A center of the outcoupling element 103 is set corresponding to the visual axis of the human eye. Preferably, the grooves for accommodating the steering element 102 and the outcoupling element 103, respectively, are provided on two surfaces on two sides of the primary mirror 100, respectively. The groove corresponding to the outcoupling element 103 should be positioned on the side facing the human eye. The groove corresponding to the steering element 102 is provided on a side facing away from the human eye and extends to an edge of the substrate close to the temple. An overall size of the formed bevel-toothed steering element 102 is relatively small, for example, with a length ranging from 10 mm to 30 mm, a width ranging from 2 mm to 8 mm, and a thickness (highness) ranging from 0.8 mm to 5 mm. This allows the steering element 102 and the corresponding compensation mirror 104 can be easily wrapped in a mirror frame. The size of the steering element 102 on a side facing the outcoupling element 103 is also smaller than the size of the outcoupling element 103 on a side facing the steering element.

The incoupling end 106 may be provided on a surface on a side of the primary mirror 101 close to the human eye. The incoupling end 106 is used for guiding a collimated light ray into the primary mirror 101. The light ray entering the primary mirror 101 undergoes total reflection within the substrate, and is reflected by the steering element 102 to achieve exit pupil expansion and steering in a first direction; and then is reflected by the outcoupling element 103 to achieve exit pupil expansion and outcoupling in a second direction.

As shown in FIG. 12, similar to the one-dimensional waveguide, in the structure of the two-dimensional arrayed waveguide, a protective film 108 and a transmittance compensation film 109 may be further provided on two surfaces of the primary mirror 101, for protecting the two surfaces of the primary mirror 101.

In this embodiment, the structures of the two bevel-toothed spectroscopic elements are the same as the structure of the bevel-toothed spectroscopic element in the one-dimensional waveguide. Both elements are bevel-toothed thin films formed by a transmission film array and a spectroscopic film array. In the two grooves provided in the primary mirror, bottom surfaces thereof are provided with tooth tip structures corresponding to the steering element and the outcoupling element structure, respectively. The compensation mirror has a same shape as the groove, and a tooth tip structure is provided on a surface facing the primary mirror. The two bevel-toothed spectroscopic elements are fastened in the two grooves of the primary mirror through the two compensation mirrors. The structures and manufacturing methods of the primary mirror, the bevel-toothed spectroscopic elements, and the compensation mirrors are the same as the content of the one-dimensional waveguide, and are not repeated herein.

In summary, the waveguide element provided in the present invention includes at least one bevel-toothed spectroscopic element, a primary mirror, and at least one compensation mirror. The bevel-toothed spectroscopic element is a bevel-toothed thin film formed by a transmission film array and a spectroscopic film array. The primary mirror has a groove therein. The compensation mirror and the bevel-toothed spectroscopic element are embedded in the groove of the primary mirror, and the bevel-toothed spectroscopic element is sandwiched between the groove and the tooth tip structure of the compensation mirror. In the waveguide element, an integrated bevel-toothed spectroscopic element is provided and placed between the primary mirror and the compensation mirror. This simplifies the structure and manufacturing process of the waveguide element. The bevel-toothed spectroscopic element may be a steering element located in a steering region, or may be an outcoupling element located in an outcoupling region. A one-dimensional arrayed waveguide element and a two-dimensional arrayed waveguide element can be manufactured by the in-mold injection molding process.

The present invention describes in detail a waveguide element with a bevel-toothed spectroscopic feature and its manufacturing method. Any obvious changes made to the invention by a person of ordinary skill in the art that do not depart from its essential content will be considered an infringement of the patent rights and may result in legal liability.

What is claimed is:

1. A waveguide element manufacturing method based on an injection molding process, comprising the following steps:
providing an injection mold of a primary mirror that comprises a plate-shaped waveguide element having a predetermined bevel-toothed groove formed therein, wherein a tooth tip structure is provided on a bottom surface of the groove;
providing a bevel-toothed spectroscopic element, wherein the bevel-toothed spectroscopic element is a bevel-toothed thin film formed by a plurality of spectroscopic films and a plurality of transmission films that are alternately arranged and sequentially connected to each other, and the bevel-toothed spectroscopic element is a profiling spectroscopic film;
placing the bevel-toothed spectroscopic element in the injection mold of the primary mirror of the waveguide element, and manufacturing a primary mirror with a bevel-toothed spectroscopic feature by an in-mold injection molding process;
providing a compensation mirror having a tooth tip structure and manufactured by the in-mold injection molding process, wherein the compensation mirror is constructed to directly form a fitting structure embeddable in the bevel-toothed groove of the primary mirror; and
embedding the compensation mirror in the groove of the primary mirror and bonding the compensation mirror and the groove of the primary mirror to sandwich the bevel-toothed spectroscopic element between the bottom surface of the groove and the tooth tip structure of the compensation mirror.

2. A waveguide element manufacturing method based on an injection molding process, comprising the following steps:
providing a primary mirror of a waveguide element having a predetermined groove and manufactured by an in-mold injection molding process, wherein a bevel-toothed tooth tip structure is provided on a bottom surface of the groove;
providing a bevel-toothed spectroscopic element, wherein the bevel-toothed spectroscopic element is a bevel-toothed thin film formed by a plurality of spectroscopic films and a plurality of transmission films that are alternately arranged and sequentially connected to each other, and the bevel-toothed spectroscopic element is a profiling spectroscopic film;
providing an injection mold of a compensation mirror having a predetermined bevel-toothed tooth tip structure, placing the bevel-toothed spectroscopic element in the injection mold of the compensation mirror, and processing a compensation mirror with a bevel-toothed spectroscopic feature by the in-mold injection molding process; and
embedding the compensation mirror in the groove of the primary mirror and bonding the compensation mirror and the groove of the primary mirror to sandwich the bevel-toothed spectroscopic element between the bottom surface of the groove and the tooth tip structure of the compensation mirror.

3. The waveguide element manufacturing method according to claim 1, wherein:
during manufacturing of the bevel-toothed spectroscopic element, a substantially planar transmissive film material is first provided, a plurality of regions on a surface of the transmissive film material are coated with a spectroscopic film to form spectroscopic film regions, and during the coating of the spectroscopic film, a flat mask is shielded between adjacent spectroscopic film regions to form a transmission film region, wherein the spectroscopic film regions and the transmission film regions are alternately arranged; and then, the plurality of spectroscopic film regions and the plurality of transmission film regions are caused in a manner of hot bending or profiling lamination to form a spectroscopic film array and a transmission film array, respectively, so that the film material has a same shape as the tooth tip structure in the groove of the waveguide element.

4. The waveguide element manufacturing method according to claim 3, wherein:
in the spectroscopic film array, a reflectivity of the spectroscopic film ranges from 5% to 80%, and transmission-reflection ratios of the plurality of spectroscopic films gradually decrease along a propagation direction of a light ray.

5. The waveguide element manufacturing method according to claim 4, wherein:
the transmission film has a light transmittance not less than 98%.

6. The waveguide element manufacturing method according to claim 5, wherein the bevel-toothed groove has an asymmetric structure, and a characteristic angle between a spectroscopic film and a transmission film that are adjacent ranges from 45° to 90°.

7. A waveguide element manufactured by the waveguide element manufacturing method according to claim 1, comprising:
at least one bevel-toothed spectroscopic element, wherein the bevel-toothed spectroscopic element is a bevel-toothed thin film formed by a plurality of transmission films and a plurality of spectroscopic films that are alternately arranged, wherein the plurality of transmission films and the plurality of spectroscopic films are arranged in different directions, and the plurality of transmission films and the plurality of spectroscopic films are alternately arranged and sequentially connected to form the bevel-toothed thin film;
a primary mirror, wherein the primary mirror is of a similar size to a diopter lens and has a groove therein, and a tooth tip structure having a same shape as the bevel-toothed thin film is provided on a bottom surface of the groove; and
at least one compensation mirror, wherein the compensation mirror has a same size as the groove, and a tooth tip structure having a same shape as the bevel-toothed thin film is provided on a side of the compensation mirror facing the groove; and
the compensation mirror is embedded in the groove of the primary mirror, and the bevel-toothed spectroscopic element is sandwiched between the tooth tip structure of the groove and the tooth tip structure of the compensation mirror.

8. The waveguide element according to claim 7, wherein:
there are two bevel-toothed spectroscopic elements: a steering element and an outcoupling element;
two grooves are provided in the primary mirror for accommodating the steering element and the outcoupling element, respectively; and
there are two compensation mirrors for fastening the steering element and the outcoupling element in the corresponding grooves, respectively.

9. The waveguide element according to claim 8, wherein:
the outcoupling element is provided at a position of the primary mirror corresponding to a visual axis of a human eye; and
the steering element is provided at an end portion of the primary mirror away from the visual axis of the human eye.

10. The waveguide element according to claim 7, wherein:
a diopter compensation sheet is provided at a position, corresponding to an outcoupling region, on a surface of a side of the waveguide element close to a human eye, and there is an air gap between the diopter compensation sheet and the waveguide element.

11. The waveguide element according to claim 7, wherein:
the waveguide element has planar or curved surfaces on two sides, and there is a surface shape difference between the two surfaces on the two sides to provide diopter compensation.

12. The waveguide element according to claim 7, wherein:
a transmittance compensation film is provided on a surface of the primary mirror in which the groove is provided, and an opening is formed at a position of the transmittance compensation film corresponding to the bevel-toothed spectroscopic element.

13. The waveguide element according to claim 12, wherein:
a protective film is provided on a surface of the primary mirror away from the compensation mirror.

14. The waveguide element according to claim 13, wherein:
the primary mirror, the protective film, and the transmittance compensation film are one-step injection molded to form a component.

15. The waveguide element manufacturing method according to claim 2, wherein:
during manufacturing of the bevel-toothed spectroscopic element, a substantially planar transmissive film material is first provided, a plurality of regions on a surface of the transmissive film material are coated with a spectroscopic film to form spectroscopic film regions, and during the coating of the spectroscopic film, a flat mask is shielded between adjacent spectroscopic film regions to form a transmission film region, wherein the spectroscopic film regions and the transmission film regions are alternately arranged; and then, the plurality of spectroscopic film regions and the plurality of transmission film regions are caused in a manner of hot bending or profiling lamination to form a spectroscopic film array and a transmission film array, respectively, so that the film material has a same shape as the tooth tip structure in the groove of the waveguide element.

16. The waveguide element manufactured by the waveguide element manufacturing method of claim 7, wherein providing a primary mirror of a waveguide element having a predetermined groove and manufactured by an in-mold injection molding process, wherein a bevel-toothed tooth tip structure is provided on a bottom surface of the groove;
providing a bevel-toothed spectroscopic element, wherein the bevel-toothed spectroscopic element is a bevel-toothed thin film formed by a plurality of spectroscopic films and a plurality of transmission films that are alternately arranged and sequentially connected to each other, and the bevel-toothed spectroscopic element is a profiling spectroscopic film;
providing an injection mold of a compensation mirror having a predetermined bevel-toothed tooth tip structure, placing the bevel-toothed spectroscopic element in the injection mold of the compensation mirror, and processing a compensation mirror with a bevel-toothed spectroscopic feature by the in-mold injection molding process; and
embedding the compensation mirror in the groove of the primary mirror and bonding the compensation mirror and the groove of the primary mirror to sandwich the bevel-toothed spectroscopic element between the bottom surface of the groove and the tooth tip structure of the compensation mirror.

17. The waveguide element manufactured by the waveguide element manufacturing method of claim 7, wherein during manufacturing of the bevel-toothed spectroscopic element, a substantially planar transmissive film material is first provided, a plurality of regions on a surface of the transmissive film material are coated with a spectroscopic film to form spectroscopic film regions, and during the coating of the spectroscopic film, a flat mask is shielded between adjacent spectroscopic film regions to form a transmission film region, wherein the spectroscopic film regions and the transmission film regions are alternately arranged; and then, the plurality of spectroscopic film regions and the plurality of transmission film regions are caused in a manner of hot bending or profiling lamination to form a spectroscopic film array and a transmission film array, respectively, so that the film material has a same shape as the tooth tip structure in the groove of the waveguide element.

18. The waveguide element manufactured by the waveguide element manufacturing method of claim 17, wherein:
in the spectroscopic film array, a reflectivity of the spectroscopic film ranges from 5% to 80%, and transmission-reflection ratios of the plurality of spectroscopic films gradually decrease along a propagation direction of a light ray.

19. The waveguide element manufactured by the waveguide element manufacturing method of claim 18, wherein:
the transmission film has a light transmittance not less than 98%.

20. The waveguide element manufactured by the waveguide element manufacturing method of claim 19, wherein the bevel-toothed groove has an asymmetric structure, and a characteristic angle between a spectroscopic film and a transmission film that are adjacent ranges from 45° to 90°.
